(19) United States
(12) Patent Application Publication
(10) Pub. No.: US 2014/0216646 A1
(43) Pub. Date: Aug. 7, 2014

(54) LASER WELDING METHOD

(71) Applicant: KOITO MANUFACTURING CO., LTD., Tokyo (JP)

(72) Inventors: Masakazu Sato, Shizuoka (JP); Yuji Sagesaka, Shizuoka (JP)

(73) Assignee: KOITO MANUFACTURING CO., LTD., Tokyo (JP)

(21) Appl. No.: 14/171,437

(22) Filed: Feb. 3, 2014

(30) Foreign Application Priority Data
Feb. 4, 2013 (JP) 2013-019827

(51) Int. Cl. B29C 65/16

(52) U.S. Cl. CPC B29C 65/1629
USPC 156/272.8

(57) ABSTRACT

A laser welding method includes positioning two resin molded products that are in contact with each other to a laser head having a mirror, and welding a contact surface of the resin molded products by a laser energy by allowing the laser beam to scan the resin molded products along a welding line with the mirror. The contact surface of the resin products has a first part on which the laser beam is incident at a first angle and a second part on which the laser beam is incident at a second angle larger than the first angle. The welding the contact surface includes controlling a luminous intensity of the laser beam so that the first part and the second part receive a substantially equal quantity of laser energy.

### CROSS-REFERENCE TO RELATED APPLICATION(S)

The present application claims the benefit of priority of Japanese Patent Application No. 2013-019827 filed on Feb. 4, 2012. The disclosures of the application are incorporated herein by reference.

### BACKGROUND

1. Technical Field

The present disclosure relates to a laser welding method in which a laser beam is applied to scan a contact surface of a resin molded product by a displacement of a mirror so that the contact surface of the resin molded product is welded.

2. Related Art

In a related art, a contact surface of a body of a lighting device for a vehicle and a lens is welded by using a laser head provided with a galvanic mirror. For instance, a welding method disclosed in patent literature 1 includes a step that a body of a lighting device and a lens are positioned with respect to a galvanic type laser head under a state that the body of the lighting device is in contact with the lens and a step that a laser beam is applied along a welding line to scan the contact surface by a mirror and weld the contact surface by a laser energy.

### LITERATURE OF RELATED ART

### Patent Literature

### [Patent Literature 1] JP-A-2011-102029

In the galvanic type laser welding method, an angle of the mirror is controlled and the laser beam is applied at high speed a plurality of times. Thus, all circumferences of the contact surface of the body of the lighting device and the lens can be molten substantially at the same time. Accordingly, even when gaps are present before the laser is applied due to irregularities of the contact surface or a deformation of the body or the lens after a molding operation thereof, since the irregular parts are allowed to collapse or crushed, the highly airtight lighting device for the vehicle having no gaps can be manufactured after the laser is applied. Further, since a tolerance of a dimensional accuracy of the resin molded product is widened, advantages are achieved that a specification of a metal mold is simplified and a cost of a molding work for a setting is reduced.

However, in the galvanic type laser welding method, since the laser head (the galvanic head) is fixed to an equipment and the angle only of the mirror in the head is controlled, the laser beam moves in a conical surface in accordance with the control of the angle of the mirror to be obliquely incident on the contact surface of the resin molded product. Then, the laser beam is partly reflected on an interface of a jig or the resin molded product to deteriorate the laser energy received by the contact surface. Especially, when the contact surface has a three-dimensional form, since an incident angle of the laser beam continuously changes, a quantity of the laser energy received by the contact surface is varied depending on parts of the contact surface. Thus, an incomplete welded state occurs in the part of shortage of energy.

FIG. 4 is schematic views showing a related-art laser welding method. The schematic views A and B respectively show different parts 53A and 53B in the contact surface of the body 51 of the lighting device and the lens 52. The laser beam 54 is constantly outputted from the galvanic head (an illustration is omitted) with a prescribed intensity. In accordance with the control of the angle of the mirror, the laser beam is incident in the part 53A at a relatively shallow or small angle (for instance, θa=20°) and in the part 53B at a relatively deep or large angle (for instance, θb=60°). In the drawings, arrow marks represent levels of the energy held by the laser beam 54 by areas.

In the case of the schematic view A, the laser beam 54 is initially reflected on an incident surface of a jig 55 to lose energy E1. Then, the laser beam is reflected on an output surface of the jig 55 to lose energy E2. Then, the laser beam is reflected on a surface (a design surface) of the lens 52 to lose energy E3. After that, the laser beam is reflected on the contact surface of the body 51 and the lens 52 to lose energy E4. In the part 53A having the shallow incident angle, since the losses of the energy respectively in surfaces of reflection are relatively small, the level (an energy transmission factor) of energy E5 received by the part 53A is about 85.8% as high as an initial energy E0 before the laser beam reaches the jig 55. When such a quantity of energy can be equally obtained in the parts respectively, a welded state of an entire part of the contact surface is preferable.

However, in the part 53B having the deep incident angle, as shown in the schematic view B, the laser beam 54 is sequentially reflected on the incident surface of the jig 55, the output surface of the jig 55, the surface of the lens 52 and the contact surface of the body 51 and the lens 52 to lose relatively large quantities of energies E1, E2, E3 and E4 in accordance with the reflections of the laser beam respectively on the surfaces. As a result, the level of energy E5 received by the part 53B falls to 69.9% as low as the initial energy E0. In order to avoid a shortage of the energy, when an output of the laser is generally set to be high, other parts having sufficient energies are subsequently allowed to collapse or crushed more than required. Thus, unnecessary burrs are generated in these parts.

The patent literature 1 proposes a technique which controls a scanning speed of the galvanic mirror in accordance with the incident angle of the laser beam in order to avoid the incomplete welded state (see the paragraph 0043). However, according to the method for controlling the scanning speed, especially, when the contact surface of the resin molded product has the three-dimensional form, it takes a long scanning time to make a round. Thus, it takes much time in a welding process which requires a continuous circulation scanning operation by the laser beam to deteriorate an assembling efficiency of the resin molded product.

### SUMMARY

One or more embodiments of the invention provides a laser welding method which can apply a uniform laser energy respectively to the parts of the contact surface and can assemble efficiently a highly airtight resin molded product in a short time.

(1) A laser welding method according to one or more embodiments of the present invention comprises:
positioning two resin molded products that are in contact with each other to a laser head having a mirror; and
welding a contact surface of the resin molded products by a laser energy by allowing the laser beam to scan the resin molded products along a welding line with the mirror,
wherein the contact surface of the resin molded products has a first part on which the laser beam is incident at a first angle and a second part on which the laser beam is incident at a second angle larger than the first angle, and
the welding the contact surface includes controlling a luminous intensity of the laser beam so that the first part and the second part receive a substantially equal quantity of laser energy.

(2) In the laser welding method, the welding line may be set in an annular form in a peripheral edge part of the resin molded products, and
the controlling the luminous intensity of the laser beam may include switching an output of a laser light source on at least two points on the welding line.

(3) In the laser welding method, the controlling the luminous intensity of the laser beam may include obtaining incident angles of the laser beam in the first part and the second part in accordance with a shape of the contact surface and determining the luminous intensities of the laser beam applied to the first and second parts in accordance with sizes of the incident angles.

(4) In the laser welding method, the controlling the luminous intensity of the laser beam may include storing the luminous intensities of the laser beam applied to the first and second parts by associating with a direction of the mirror.

(5) In the laser welding method, the controlling the luminous intensity of the laser beam may include storing the luminous intensities of the laser beam applied to the first and second parts by associating with positions on the welding line.

In the laser welding method according to one or more embodiments of the present invention, since a luminous intensity of the laser beam is controlled so that a part having a large incident angle and a part having a small incident angle may receive a substantially equal quantity of laser energy, a uniform laser energy can be applied respectively to the parts of the contact surface and a highly airtight resin molded product can be efficiently assembled in a short time.

### BRIEF DESCRIPTION OF THE DRAWINGS

FIG. 1 is an overview diagram showing a laser welding system according to one or more embodiments of the invention.

FIG. 2 is a schematic view showing processes of a laser welding method performed by the system of FIG. 1.

FIG. 3 is schematic views showing effects in the laser welding method of FIG. 2.

FIG. 4 is schematic views showing a related-art laser welding method.

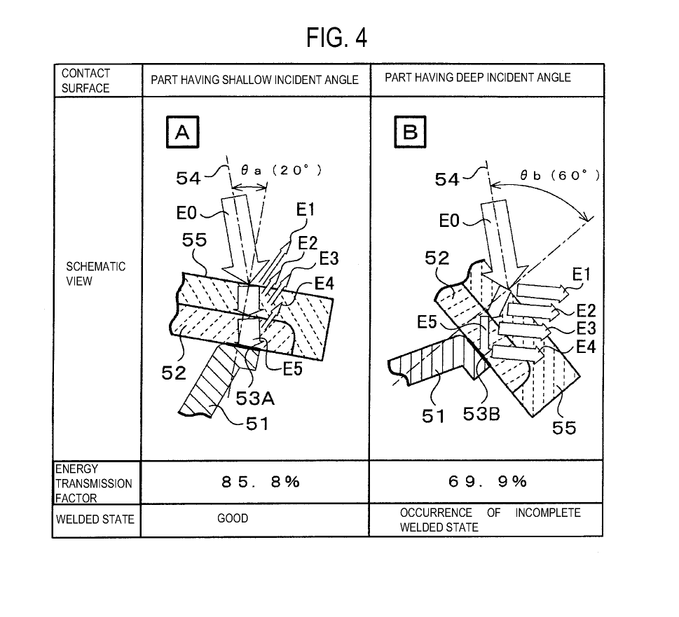

### DETAILED DESCRIPTION

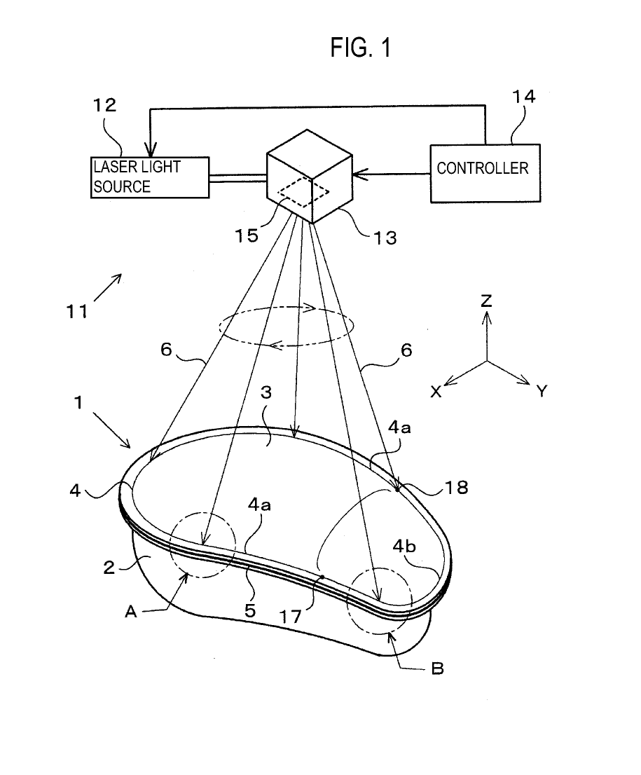

Embodiments of the present invention will be described below by referring to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. A laser welding system 11 shown in FIG. 1 is used to weld a body 2 of a lighting device 1 for a vehicle to a lens 3. The body 2 is formed with a light absorbing resin such as ASA, ABS or the like and the lens 3 is formed with a light transmitting resin such as acryl, polycarbonate or the like. To a peripheral edge part of the lighting device 1 for the vehicle, an endless annular welding line 4 is set. Thus, a contact surface 5 of the body 2 and the lens 3 is welded along the welding line 4 by a laser beam 6.

In the laser welding system 11, a laser light source 12, a laser head 13 and a controller 14 are provided. The laser head 13 is fixed to a lighting device production facility. The laser head 13 incorporates therein a galvanic mirror 15 (one of a plurality of mirrors is shown) and an optical system (an illustration is omitted). The galvanic mirror 15 allows the laser beam 6 to scan the lighting device 1 for the vehicle in an X-axis direction and a Y-axis direction. The optical system adjusts a focal point position of the laser beam 6 in a Z-axis direction. The controller 14 controls an output of the laser light source 12 and a direction of the mirror 15 and the focal point position, so that the laser beam 6 can be allowed to three-dimensionally scan the lighting device for the vehicle along the welding line 4.

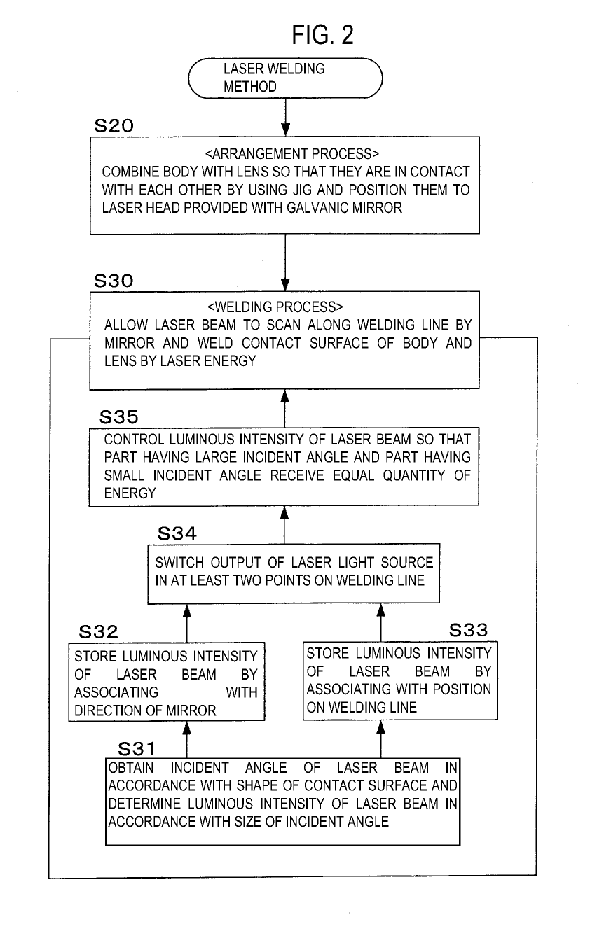

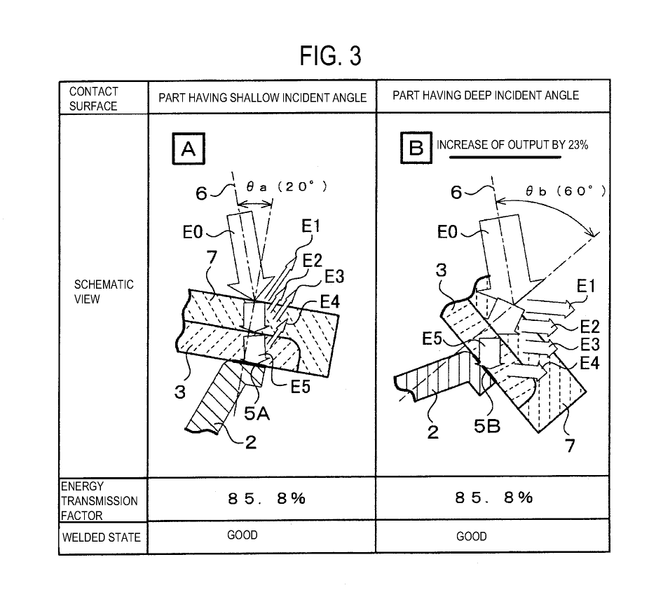

The laser welding method includes, as shown in FIG. 2, an arrangement process (S20) and a welding process (S30). In the arrangement process, a jig 7 (see FIG. 3) is used to combine the body 2 with the lens 3 so that the body 2 is in contact with the lens 3 and position the body 2 and the lens 3 to the laser head 13 provided with the mirror 15. As shown in FIG. 1, the contact surface 5 of the body 2 and the lens 3 has a three-dimensional form adapted to an outer surface of a vehicle body. On the welding line 4, are provided a part 4b relatively far from a laser output part of the laser head 13 and a part 4a relatively near to the laser output part of the laser head 13.

As shown in FIG. 2, in the welding process, the laser beam 6 is allowed to scan the lighting device 1 for the vehicle along the welding line 4 by the galvanic mirror 15 to weld the contact surface 5 of the body 2 and the lens 3 together by laser energy. Specifically, in accordance with the shape of the contact surface 5, incident angles of the laser beam 6 in at least two parts of the contact surface 5 are obtained by estimation or a calculating function of the controller 14 to determine luminous intensities of the laser beam 6 which is applied respectively to the parts depending on sizes of the incident angles (S31).

Here, as the parts of the contact surface 5, as shown in FIG. 3, a first part 5A on which the laser beam 6 is incident at a first angle (θa) and a second part 5B on which the laser beam 6 is incident at a second angle (θb) larger than the first angle may be exemplified. In the case of the lighting device 1 for the vehicle shown in FIG. 1, the part 4a on the welding line 4 corresponds to the first part 5A and the laser beam 6 is incident on the part 4a at a relatively shallow (small) angle from the laser head 13. The part 4b on the welding line 4 corresponds to the second part 5B and the laser beam 6 is incident on the part 4b at a relatively deep (large angle).

After the luminous intensities of the laser beam 6 are determined, the luminous intensities of the laser beam 6 to be outputted to the first and second parts 5A and 5B by the laser head 13 are stored in a memory of the controller 14 by associating with directions (tilting angles) of the galvanic mirror 15 (S32). Alternatively, the luminous intensities of the laser beam 6 to be outputted to the parts 5A and 5B are stored by associating with a plurality of positions including the part 4a and the part 4b on the welding line 4 (S33). Further, the luminous intensities of the laser beam 6 to be outputted to the parts 5A and 5B may be stored by associating with the directions of the galvanic mirror 15 and also with the positions including the part 4a and the part 4b on the welding line 4. In such a way, a circulation scanning operation by the laser beam 6 can be continuously carried out at high speed.

In the course of the circulation scanning operation, the controller 14 switches the luminous intensity of the laser light source 12 in at least two points on the welding line 4 (S34). Thus, for instance, as shown in FIG. 1, the output of the laser light source 12 is switched from “low” to “high” at a point 17 where the laser beam 6 moves from the part 4a to the part 4b on the welding line 4. The output of the laser light source 12 is switched from “high” to “low” at a point 18 where the laser beam 6 moves from the part 4b to the part 4a. In FIG. 1, the two switch points 17 and 18 are exemplified. However, in the contact surface 5 where a variation range of the incident angle is large, the number of switch points can be more increased. Further, at a plurality of points where the incident angles suddenly change, the luminous intensity of the laser beam 6 can be changed stepwise or can be continuously changed so as to meet the three-dimensional form of the contact surface 5.

In accordance with the above-described procedure (S31 to S34), in the welding process, the luminous intensity of the laser beam 6 is controlled so that the part having the large incident angle and the part having the small incident angle may receive a substantially equal quantity of energy (S35). For instance, as shown in FIG. 3, the output of the laser light source 12 which is applied to the part 5B is increased more by 23% than the output of the laser light source 12 which is applied to the part 5A so that the part 5A having the shallow incident angle (θa=20°) and the part 5B having the deep incident angle (θb=60°) may receive the equal quantity of energy E0.

In such a way, in the part 5B having the deep incident angle, an energy loss (E1+E2+E3+E4) due to a reflection of the laser beam 6 is compensated, so that an energy transmission factor can be improved to 85.8% as high as an initial energy E0 like the part 5A having the shallow incident angle. As a result, uniform laser energy is equally applied respectively to the parts of the contact surface 5 to closely stick the surfaces of the body 2 and the lens 3 together in all the periphery of the lighting device in a preferable state. Thus, the highly airtight lighting device 1 for the vehicle can be manufactured. Further, as compared with the method by the speed control, the continuous circulation scanning operation by the laser beam 6 can be carried out at high speed from beginning to end and a welding process time can be shortened. Accordingly, the lighting device 1 for the vehicle can be efficiently assembled.

The body 2 and the lens 3 merely show one examples of the resin molded product. The method according to one or more embodiments of the present invention may be applied to a laser welding method of a reflector or an extension, or may be applied to various kinds of resin molded products except the lighting device for the vehicle. Further, the output of the laser light source 12 may be controlled manually or automatically. The incident angle of the laser beam 6 may be detected by a sensor. In addition thereto, structures of parts or the procedures may be suitably changed within a range that does not deviate from a scope of the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A laser welding method comprising:
positioning two resin molded products that are in contact with each other to a laser head having a mirror; and
welding a contact surface of the resin molded products by a laser energy by allowing the laser beam to scan the resin molded products along a welding line with the mirror,
wherein the contact surface of the resin molded products has a first part on which the laser beam is incident at a first angle and a second part on which the laser beam is incident at a second angle larger than the first angle, and
wherein the welding the contact surface includes controlling a luminous intensity of the laser beam so that the first part and the second part receive a substantially equal quantity of laser energy.

2. The laser welding method according to claim 1,
wherein the welding line is set in an annular form in a peripheral edge part of the resin molded products, and
wherein the controlling the luminous intensity of the laser beam includes switching an output of a laser light source on at least two points on the welding line.

3. The laser welding method according to claim 1, wherein the controlling the luminous intensity of the laser beam comprises:
obtaining incident angles of the laser beam in the first part and the second part in accordance with a shape of the contact surface, and
determining the luminous intensities of the laser beam applied to the first and second parts in accordance with sizes of the incident angles.

4. The laser welding method according to claim 3, wherein the controlling the luminous intensity of the laser beam includes storing the luminous intensities of the laser beam applied to the first and second parts by associating with a direction of the mirror.

5. The laser welding method according to claim 3, wherein the controlling the luminous intensity of the laser beam includes storing the luminous intensities of the laser beam applied to the first and second parts by associating with positions on the welding line.
